(19) United States
(12) Patent Application Publication
(10) Pub. No.: US 2026/0210915 A1
(43) Pub. Date: Jul. 23, 2026

(54) Thermoacoustic System

(71) Applicant: QinetiQ Limited, Hampshire (GB)

(72) Inventors: David Tatnell, Exeter (GB); David Horsell, Exeter (GB)

(21) Appl. No.: 19/138,542

(22) PCT Filed: Dec. 12, 2023
(86) PCT No.: PCT/EP2023/085304

§ 371 Date: Jun. 12, 2025

(30) Foreign Application Priority Data
Dec. 13, 2022 (GB) 2218761.1

(51) Int. Cl. G01N 29/34; G01N 29/04; G10K 15/04; H01B 1/02

(52) U.S. Cl. CPC G01N 29/34; G01N 29/043; H01B 1/023; G10K 15/04

(57) ABSTRACT

There is disclosed a thermoacoustic system. The system comprises a thermocouple junction and an electronic signal generator for generating an acoustic frequency driving signal across the junction, which causes the system to generate an acoustic wave via the Peltier effect.

### CROSS-REFERENCE TO RELATED APPLICATIONS

The present application is a U.S. National Phase Application pursuant to 35 U.S.C. § 371 of International Application No. PCT/EP2023/085304, filed Dec. 12, 2023, which claims priority to Great Britain Patent Application No. 2218761.1, filed Dec. 13, 2022. The entire contents of these applications are herewith incorporated by reference into the present application.

### FIELD

This specification concerns thermoacoustic systems, specifically systems and methods of generating and/or detecting acoustic waves using thermoelectric and thermoacoustic effects.

### BACKGROUND

Acoustic emitters such as loudspeakers typically work by converting electrical energy into mechanical energy. The mechanical energy drives a membrane to move in a manner that compresses air to generate acoustic waves. The acoustic waves are primarily first harmonic and reciprocal with an electronic driving signal which drives the mechanical motion, which makes such emitters suitable for accurate audio generation and reproduction.

Mechanical-based acoustic systems are difficult and/or expensive to fabricate at small scale, owing to their complex arrangement of moving parts and their lack of robustness in mechanically or thermally hostile environments. Such systems are also limited in that they have resonant properties that could negatively impact their ability to generate sound output for a given driving signal.

It is known that acoustic waves can be generated via other transduction mechanisms, including the thermoacoustic effect. The thermoacoustic effect is the conversion of heat energy to acoustic energy (or vice versa). For example, where a changing temperature gradient is present across a solid, the heat energy can drive local pressure oscillations in a surrounding medium, e.g. a gas, to generate acoustic waves. Many different heat sources can be used to supply the heat energy. One example is to utilize Joule-based heating, where an alternating current (AC) electronic driving signal is passed through an electrical conductor to induce Joule-based resistive heating, where the Joule heat varies with time and is exchanged with the surrounding medium (e.g. air) to produce acoustic waves.

While thermoacoustic systems may be able to generate a single frequency tone, they are not suitable for creation of complex acoustic waves, such as spoken voice, instrumental music, or other sound effects. This is because, for Joule-based thermoacoustics, the acoustic waves generated by the system are not reciprocal with the driving signal. That is, there is not a mutual correspondence between the waveforms of the driving signal and the acoustic waves; the frequency component(s) of the acoustic waves generated by the system is not the same as that of the input driving signal. Further, the acoustic waves occur at the second harmonic of the driving signal and therefore suffer from harmonic distortions, i.e. where the waveform is distorted and altered as a result of harmonics. Further, such systems suffer from low efficiency because they produce large amounts of waste heat.

An object of the present disclosure is to provide an improved thermoacoustic system that does not suffer from the above mentioned disadvantages.

### SUMMARY

According to an aspect of the present disclosure, there is provided a thermoacoustic system comprising:
a pair of electrical conductors comprising a first electrical conductor and a second electrical conductor formed of dissimilar materials, wherein the first and second electrical conductors connect at an interface to form an electrical (thermocouple) junction; and
an electronic signal generator for generating an alternating current driving signal across the electrical junction, thereby causing the system to generate an acoustic wave that is emitted from the interface.

The present disclosure harnesses Peltier thermoelectric effects for thermoacoustic wave generation, which is in contrast to conventional acoustic emitters that use other transduction mechanisms, such as electro-mechanically driven motion or Joule-based thermoacoustic effects.

Although thermocouples are known in the art, their use in combination with a signal generator which applies an AC driving signal across the thermocouple junction to generate acoustic waves is considered to be both novel and inventive. This is because the suitability of thermocouples as a thermoacoustic device has not been recognized previously. Instead, thermocouples are typically used in one of two ways: firstly, as a thermometer; and secondly, as a thermoelectric cooler.

In the first example where the thermocouple is used as a thermometer, the thermocouple is not connected to a signal generator but is instead connected to a voltage reader which measures a voltage induced across the two conductors by virtue of a different temperature gradient along each conductor. The measured voltage is then converted to a temperature reading, based on a predetermined relationship. In the second example, where the thermocouple is used as a thermoelectric cooler, a thermocouple junction is connected in series with a DC power source. A DC current is then supplied to the junction such that the thermocouple junction will absorb heat (thereby cooling the space around it).

The electrical conductors may be formed of dissimilar materials in that they have different values of a thermoelectric coefficient. The electrical conductors may be dissimilar materials in that they are different materials entirely.

The thermoelectric coefficient may be one of the Seebeck, Peltier, or Thomson coefficients.

The first electrical conductor may comprise Copper and the second electrical conductor may comprise Constantan.

The first electrical conductor and/or the second electrical conductor may comprise magnetic materials. This may be advantageous in that the amplitude of first harmonic waves will be much greater than that generated by non-magnetic materials.

The first electrical conductor may comprise Chromel and the second electrical conductor may comprise Alumel.

The electronic signal generator may be configured to generate a driving signal having a driving current or bias current equal to or greater than a predetermined threshold value corresponding to a minimum thermoacoustic response at the first harmonic. This may further minimize Joule heating to enhance Peltier dominance and minimize second harmonic distortions.

The driving signal may have a mean amplitude of zero, i.e. a DC balanced signal having no DC bias. A DC bias may introduce Joule heating. Therefore, it may be advantageous to use a DC balanced driving signal to further minimize Joule heating and thus harmonic distortion associated therewith. In the absence of a DC bias, the system equilibrium temperature may also be lowered, increasing system efficiency. That is, it may lower the system equilibrium temperature, thereby increasing efficiency.

The electronic driving signal may have a mean amplitude equal to or greater than a predetermined threshold value corresponding to a minimum thermoacoustic response at the first harmonic.

The driving signal may have a drive frequency between 20 Hz and 20 KHz.

The first and second electrical conductors may be thin-film conductors deposited onto a substrate. The use of thin-film materials may be advantageous to provide thin and robust emitters. The structure of the emitter, i.e. having no moving parts, lends itself well to small scale fabrication methods such as thin film techniques.

The thermoacoustic system may comprise two pairs of electrical conductors, wherein the pairs are electrically connected in series such that the second electrical conductor of a first pair forms the first electrical conductor of a second pair. For an AC driving signal, this will result in adjacent junctions oscillating out-of-phase, thereby creating an acoustic dipole.

The thermoacoustic system may further comprise a third electrical conductor, wherein the first, second and third electrical conductors comprise two different electrically conductive materials which are connected in series in an alternating manner. This forms an array of series connected thermocouple junctions. The specific materials used may be selected such that, when an AC signal is applied across the array, an acoustic wave having predictable frequency characteristics specific to that combination of materials is generated.

According to another aspect of the present disclosure, there is provided a thermoacoustic system comprising:
a first pair of electrical conductors and a second pair of electrical conductors, wherein each pair comprises a first electrical conductor and a second electrical conductor formed of dissimilar materials, wherein the first and second electrical conductors connect at an interface 5 to form an electrical junction;
at least one electronic signal generator for generating an alternating current driving signal across the electrical junctions, thereby causing the system to generate acoustic waves that are emitted from the interfaces; and
a controller configured to cause the at least two pairs of electrical conductors to emit pulses of acoustic waves in a phase or time delayed manner.

According to another aspect of the present disclosure, there is provided a thermoacoustic system for probing an electrically conductive sample, the system comprising:
a first electrical conductor formed of a dissimilar material to that of the sample; and
an electronic signal generator;
wherein:
the first electrical conductor is movable to a contact position at which it contacts the sample to form an electrical junction at an interface therebetween; and
the electronic signal generator is configured to generate a driving signal across the electrical junction, to generate an acoustic wave that enters the sample from the interface.

According to another aspect of the present disclosure, there is provided a thermoacoustic system comprising:
a pair of electrical conductors comprising a first electrical conductor and a second electrical conductor formed of dissimilar materials, wherein the first and second electrical conductors connect at an interface to form an electrical junction;
an electronic signal generator for generating a driving (AC or DC) signal across the electrical junction; and
a detector (e.g. a resistor-voltmeter or an Ammeter) configured to detect a thermoelectric voltage or current that is induced across the electrical junction in response to an acoustic wave impinging the system at the interface.

According to another aspect of the present disclosure, there is provided a method of generating an acoustic wave, comprising:
providing a first electrical conductor and a second electrical conductor, which is formed of a dissimilar material to the first electrical conductor, wherein the first electrical conductor and the second electrical conductor connect at an interface to form an electrical junction at the interface; and
using an electronic signal generator to generate an alternating current driving signal across the electrical junction, thereby generating an acoustic wave that is emitted from the interface.

The method may use a thermoacoustic system as described above in any preceding statement. However, in alternative embodiments, the second electrical conductor may itself be a sample that is to be interrogated with acoustic waves, and the first electrical conductor may be a probe that is brought into contact or wire bond with the sample to form the electrical junction at the interface.

According to another aspect of the present disclosure, there is provided a method of detecting an acoustic wave using a thermoacoustic system having a pair of electrical conductors comprising a first electrical conductor and a second electrical conductor formed of dissimilar materials, wherein the first and second electrical conductors are connected at an interface to form an electrical junction;
the method comprising:
using an electronic signal generator to maintain a (AC or DC) driving signal across the electrical junction; and
using a detector to detect a voltage or current that is induced across the electrical junction in response to an acoustic wave impinging the system at the interface.

Any device(s), processor(s), controller(s), detector(s) and/or other functional element(s) (and associated elements) described herein may comprise any suitable computer processing circuitry to cause performance of the methods described herein and as illustrated in the Figures. The device, processor or controller may comprise: at least one application specific integrated circuit (ASIC); and/or at least one field programmable gate array (FPGA); and/or single or multi-processor architectures; and/or sequential (Von Neumann)/parallel architectures; and/or at least one programmable logic controllers (PLCs); and/or at least one microprocessor; and/or at least one microcontroller; and/or a central processing unit (CPU), to perform the methods.

The device(s), processor(s), controller(s), detector(s) and/or functional element(s) may include at least one microprocessor and may comprise a single core processor, may comprise multiple processor cores (such as a dual core processor or a quad core processor), or may comprise a plurality of processors (at least one of which may comprise multiple processor cores).

The device(s), processor(s), controller(s), detector(s) and/or functional element(s) may comprise and/or be in communication with one or more memories that store the data described herein, and/or that store software for performing the processes described herein. The memory may be any suitable non-transitory computer readable storage medium, data storage device or devices, and may comprise a hard disk and/or solid state memory (such as flash memory). The memory may be permanent non-removable memory, or may be removable memory (such as a universal serial bus (USB) flash drive).

The memory may store a computer program comprising computer readable instructions that, when read by a processor or controller, causes performance of the methods described herein, and as illustrated in the Figures. The computer program may be software or firmware, or may be a combination of software and firmware. In some examples, the computer readable instructions may be transferred to the memory via a wireless signal or via a wired signal.

The skilled person will appreciate that except where mutually exclusive, a feature described in relation to any one of the above aspects may be applied to any other aspect. Furthermore, except where mutually exclusive, any feature described herein may be applied to any aspect and/or combined with any other feature described herein.

### BRIEF DESCRIPTION OF THE DRAWINGS

Embodiments of the disclosure will now be described by way of non-limiting example with reference to the accompanying drawings, in which:

FIG. 1 is a schematic diagram illustrating a thermoacoustic system in accordance with an embodiment of the present disclosure;

FIG. 2 is a graph illustrating the thermal response of the thermoacoustic system of FIG. 1 when driven by a driving signal having a driving current of 0.1 Amps at a frequency of 1 Hz;

FIG. 3 shows two graphs illustrating the acoustic frequency spectrum of sound generated by the thermoacoustic system of FIG. 1 for a driving signal having: a) a single drive frequency of 10 kHz; and b) two drive frequencies of 10 kHz and 15 kHz;

FIG. 4 is a graph which illustrates a relationship between the acoustic wave response at both first and second harmonics and the driving current of the driving signal applied to the thermoacoustic system;

FIG. 5 is a diagram schematically illustrating a thermoacoustic system in accordance with another embodiment of the present disclosure;

FIG. 6 is a diagram schematically illustrating a thermoacoustic system in accordance with another embodiment of the present disclosure;

FIG. 7 is a diagram schematically illustrating a thermoacoustic system in accordance with another embodiment of the present disclosure;

FIG. 8 is a diagram schematically illustrating a thermoacoustic system in accordance with another embodiment of the present disclosure; and

FIG. 9 is a diagram schematically illustrating a thermoacoustic system in accordance with another embodiment of the present disclosure.

Like reference numerals are used throughout the drawings to refer to like features.

### DETAILED DESCRIPTION

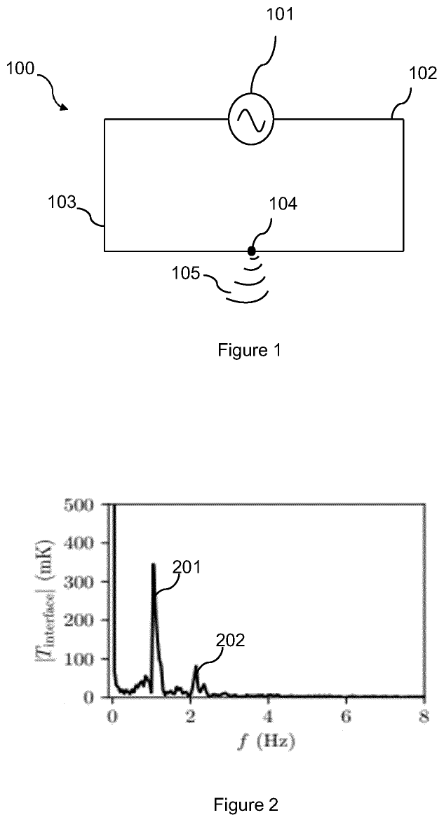

FIG. 1 is a schematic diagram illustrating a thermoacoustic system 100 in accordance with an embodiment of the present disclosure.

There is generally shown a closed electrical circuit comprising an electronic signal generator 101, and a pair of electrical conductors comprising a first wire conductor 102 and a second wire conductor 103 which are connected (e.g. welded or fused, etc.) to one another at an interface to form an electrical junction 104. The electronic signal generator 101 is connected in series between the ends of the first wire conductor 102 and the second wire conductor 103 opposite the electrical junction 104.

The first wire conductor 102 and the second wire conductor 103 are formed of dissimilar electrically conductive materials such that the electrical junction 104 is in effect a thermocouple junction. The electrically conductive materials differ by virtue of their material properties, such as their thermoelectric coefficients, e.g. they will have different values of the Seebeck coefficient, Peltier coefficient or Thomson coefficient. In the present embodiment, the first wire conductor 102 is a Chromel wire and the second wire conductor 103 is an Alumel wire. Chromel is a commercially available off the shelf (COTS) alloy which comprises approximately 90% nickel and 10% chromium by weight. Alumel is another COTS alloy which comprises approximately 95% nickel, 2% aluminium, 2% manganese, and 1% silicon by weight.

The electronic signal generator 101 is configured (e.g. under the direction of an electronic microprocessor controller) to generate an alternating current (AC) driving signal, which is applied to the circuit and across the electrical junction 104 via the first wire conductor 102 and the second wire conductor 103. The driving signal, I(t), may have the following form:

$$I ( t ) = {I}_{0} + {I}_{1} sin ( 2 π ft ) \qquad ( 1 )$$

where t is the time, I₀ is a DC bias current of the signal, I₁ is the amplitude of the driving current, and f is the drive frequency of the sine wave.

The example driving signal of equation 1 is a continuous wave signal having a single drive frequency. However, the driving signal may instead comprise multiple drive frequencies. Further, the driving signal may be an audio signal (or some other, e.g. information-bearing, signal) which is formed by modulation of an AC carrier signal. The frequency component(s) of the driving signal comprises at least one acoustic drive frequency, which is regarded as a frequency that is within the audio range (between 20 Hz to 20,000 Hz) or the ultrasound range (at or above 20,000 Hz).

It will be appreciated here that when a current is passed through an electrical conductor, there will be some Joule-based heating of the conductor. It is also generally known that, when a current is passed through the junction of a thermocouple, heat will be generated or absorbed at the junction via the Peltier effect (where heating/cooling depends on the direction of current flow across the junction). This thermal response of the system 100 to the driving signal will cause local pressure oscillations in the surrounding medium.

The Applicant has recognized, however, that the heat (and thus local pressure oscillations) generated by the Peltier effect is linear with respect to the AC driving signal, and can thus be modulated at the acoustic drive frequencies of that signal to generate an acoustic wave. This effect is a surprising one, given that heat generated by the Peltier effect is typically considered to be a ‘DC’ effect.

The Applicant has also recognized that the application of an AC driving signal across the electrical junction 104 of FIG. 1 will cause heat to be generated predominantly as a result of the Peltier effect, as opposed to Joule-based effects. That is, the thermal response of the system 100 as a result of the Peltier effect is greater in amplitude than the thermal response caused by Joule effects. Correspondingly, the thermoacoustic response of the system 100 to the driving signal will also be predominantly as a result of the Peltier effect.

This Peltier dominance may be at least partly attributable to the spatial distribution of the thermal response to the driving signal. Specifically, it has been found that the heat generated by the Peltier effect is localised and manifests as a point heat source located entirely at the interface which forms the junction 104, whereas the Joule heat is dissipated throughout the branches of the first wire conductor 102 and the second wire conductor 103.

Further still, Peltier dominance may be a result of the AC driving signal causing an increased temperature differential at the junction 104 interface. For example, heat will be continuously generated and absorbed in an alternating manner at the electrical junction 104, by virtue of the AC driving signal alternating the current flow direction across the junction 104 interface. Actively heating and cooling a thermocouple junction 104 in this manner is in contrast to conventional thermoacoustic systems, where an AC driving signal is passed through a single-material conductor (instead of a thermocouple junction) such that acoustic waves are simply generated by small fluctuations in the magnitude of Joule-based heat generated. Conventional thermoacoustic systems are not actively cooled as part of the acoustic wave generation process, nor do they alternate between heating and cooling to increase a temperature differential and thus the magnitude of local pressure oscillations in the medium (e.g. air) around the conductor.

By providing a thermoacoustic system that minimizes the Joule heat while simultaneously maximizing the Peltier heat, the present disclosure is able to generate acoustic waves with very low harmonic distortion. As stated above, heat generated by the Peltier effect is linear with respect to the driving signal, such that resultant acoustic waves will occur at the first harmonic of the driving signal. This may be advantageous in that the acoustic waves will be reciprocal with (i.e. have the same frequency components as) the driving signal and exhibit reduced harmonic distortions typically associated with Joule heating, thereby enabling accurate acoustic generation and reproduction.

Further, the thermoacoustic system 100 is advantageous over mechanical loudspeaker devices in that it does not require moving parts to generate the acoustic waves; it can generate acoustic waves while stationary, thereby providing a more robust system that is also easier to fabricate, e.g. at small scale.

To demonstrate that the present disclosure provides a thermoacoustic response predominantly via the Peltier effect, thermal and acoustic measurements were performed with respect to the thermoacoustic system 100 described above with respect to FIG. 1.

FIG. 2 is a graph which illustrates the thermal response of the thermoacoustic system 100, which was measured directly using a low frequency thermal imaging camera.

In this example embodiment, the first wire conductor 102 and the second wire conductor 103 each has a branch length of 1 m and a diameter of 0.5 mm, resulting in a total resistance of 6 ohms. The signal generator 101 was used to generate a driving signal, I(t), having zero DC bias current (i.e. where I₀=0), a driving current of 0.1 Amps (I₁=0.1), and a single drive frequency of 1 Hz (f=1). A value of 1 Hz was selected for the drive frequency in order to match the low frequency imaging capability of the thermal imaging camera, for the purpose of demonstrating the thermal response.

The graph in FIG. 2 shows the absolute values of the average temperature of the junction 104 as a function of the drive frequency. Looking at the spectral response, the presence of both first and second harmonics is evident by the two peaks 201, 202 in average temperature occurring at frequencies of 1 Hz and 2 Hz, respectively. However, the thermal response is primarily first harmonic given that the peak 201 at a frequency of 1 Hz, which corresponds to the drive frequency of the driving signal, is significantly greater than the peak 202 at a frequency of 2 Hz which corresponds to the second harmonic of the 1 Hz driving signal.

Further, although not shown, it was found that the spatial distribution of the temperature field at each harmonic revealed that the temperature field generated at the first harmonic (i.e. 1 Hz) occurs primarily at the interface, whereas the temperature field at the second harmonic (2 Hz) is more global, which indicates that the second harmonic is caused by resistive Joule-based heating.

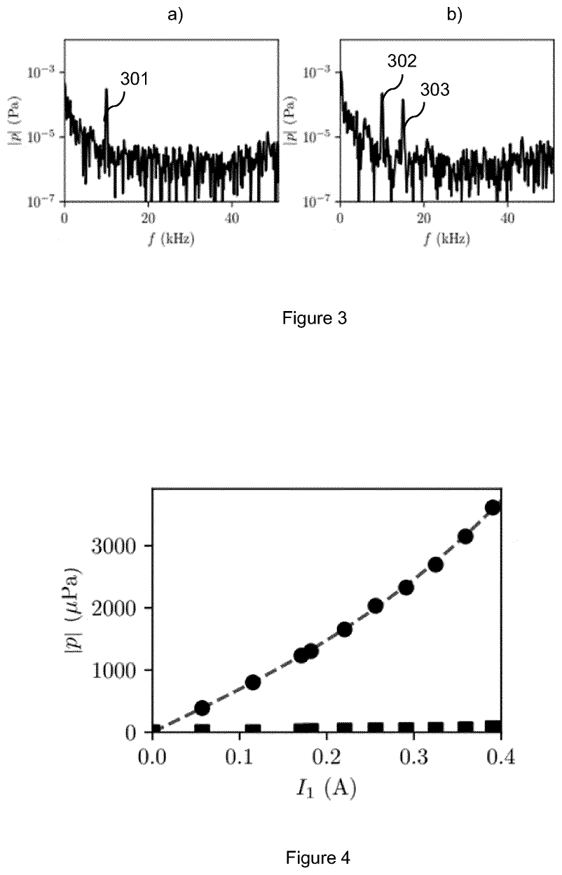

FIG. 3 is an acoustic frequency spectrum illustrating the acoustic response (measured in Pascal units of pressure) generated by the thermoacoustic system 100 of FIGS. 1 and 2.

Acoustic measurements were performed with a microphone normal to the electrical junction 104 at a distance of 30 cm. The spectral response was measured for both: a) a driving signal having a single drive frequency of 10 kHz (as shown in FIG. 3a); and b) a driving signal having two drive frequencies of 10 kHz and 15 kHz (as shown in FIG. 3b). The driving signal had zero DC bias current (i.e. where I₀=0).

The resulting spectra clearly show first harmonic acoustic responses, with no discernible second harmonic. For example, in the single drive frequency case of FIG. 3a, there is a single discernible peak 301 in acoustic pressure at the drive frequency of 10 Hz. In the multi-frequency case of FIG. 3b, there are only two discernible peaks in acoustic pressure: a first peak 302 at the first drive frequency of 10 Hz and a second peak 303 at the second drive frequency of 15 Hz.

Accordingly, in both cases, the system 100 was able to accurately reproduce the frequency components of the electronic driving signal as acoustic waves, without any distortions. That is, the system 100 was able to generate acoustic waves that are reciprocal with the original driving signal by virtue of their mutual correspondence. This is an especially surprising result given that it was expected that the various frequency components of an arbitrary multi-frequency driving signal would generate corresponding heterodyne and second harmonic distortions due to Joule heating.

The dependence of the acoustic response on the driving current was also measured, as will now be described with respect to FIG. 4.

FIG. 4 is a graph which illustrates a relationship between the magnitude of the driving current |I₁| and the magnitude of the acoustic response (measured in microPascal units of pressure) at both the first harmonic (indicated by circles in FIG. 4) and the second harmonic (squares). In this specific example, the acoustic response was measured for different driving signals, where each driving signal had a bias current I₀=0, a drive frequency f=10 kHz, but the driving current I was varied between values of 0 A and 0.4 A.

It was found that the first harmonic response and the second harmonic response scale differently with the driving current, and that the first harmonic response increases in magnitude more rapidly than the second harmonic response with increasing driving current. Specifically, the first harmonic response demonstrates a cubic dependence on the driving current, whereas the second harmonic response has a quadratic dependence on the driving current.

Accordingly, by appropriate selection of the driving current based on these predetermined relationships, it may be possible to tailor the magnitude of the first harmonic response relative to the magnitude of the second harmonic response of the system 100. This may be advantageous to maximize the first harmonic, Peltier response while minimizing the second harmonic, Joule response and its associated distortions. For example, the electronic signal generator 100 may supply a driving signal having a driving current which is equal to or greater than a predetermined minimum threshold driving current value. The minimum threshold driving current value may be the value at which the first harmonic (Peltier) response is significantly dominant over second harmonic (Joule) response, or at which a minimum acceptable magnitude of first harmonic sound is generated.

It will be appreciated here that the minimum threshold value may differ from one thermoacoustic system to another, depending on a number of factors such as the materials used for the thermocouple junction 104. Thus the minimum threshold value may be predetermined for the thermoacoustic system in question and should not be limited to a specific value.

Embodiments of the disclosure have been described above with respect to using a DC balanced driving signal, i.e. where I₀=0. Indeed, there may be some advantages to using a DC balanced driving signal. For example, a DC balanced driving signal may avoid unnecessary Joule heating and its associated harmonic distortions, which would typically occur if a DC bias was applied. Further, the system equilibrium temperature may be lower when a DC balanced driving signal is applied, thereby increasing system efficiency.

However, it has been found that the magnitude of the first harmonic response has a quadratic dependence on the DC bias current I₀. Therefore, applying a DC bias current will increase the first harmonic response of the system 100, albeit at a small expense of system efficiency. Further, by appropriate selection of the DC bias current I₀, it may be possible to tailor (e.g. maximize) the acoustic output of the system 100. For example, the DC bias current may be set to a value equal to or greater than a predetermined threshold value that produces a minimum acceptable magnitude of acoustic response at the first harmonic.

While the example embodiments have been described above with respect to the electrical conductors being in the form of wires, this is not required. The electrical conductors can be formed of thin film elements, for example. Indeed, any type of conductors could be used in the embodiments described herein, as may be desired or appropriate for a given application.

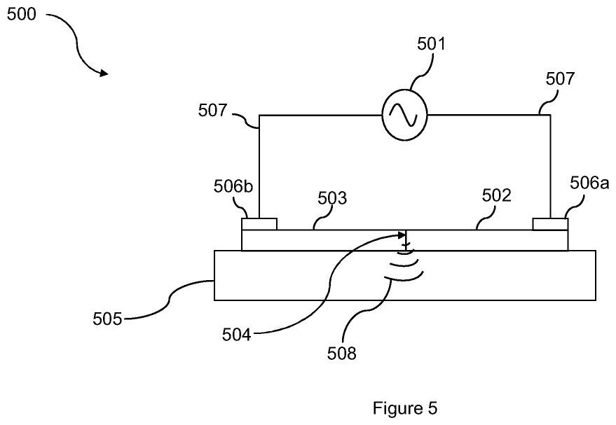

FIG. 5 is a schematic diagram illustrating one such embodiment of the disclosure in which the electrical conductors are formed of thin film elements.

There is generally shown a thermoacoustic system 500 which is in the form of a closed electrical circuit comprising an electronic signal generator 501 in series connection with a pair of electrical conductors 502, 503. The pair of electrical conductors 502, 503 are connected to one another at an interface to form an electrical junction 504. This may be achieved by overlapping the two electrical conductors 502, 503 at the junction 504.

The pair of electrical conductors comprises a first thin film conductor 502 and a second thin film conductor 503 which are deposited onto a common substrate 505. The substrate 505 is an electrically and thermally insulating material, such as fused silicon dioxide, such that the generated heat will be predominantly transferred to the air for acoustic wave generation. The first thin film conductor 102 and the second thin film conductor 103 are formed of dissimilar electrically conductive materials such that they in effect form a thermocouple junction at the interface. The thin film conductors 502, 503 may be manufactured using conventional techniques known in the art, or may be purchased as commercial-off-the-shelf (COTS) products.

At the end of the first thin film conductor 502 opposite the junction 504, there is provided a first electrical contact 506a which electrically connects the first thin film conductor 502 to the signal generator 501 via a respective electrical wire 507. A second electrical contact 506b is located at the end of the second thin film conductor 503 opposite the junction 504 and connects to the signal generator 501 via another electrical wire 507. The wires 507 are made of the same (e.g. Copper) material. The wires 506 transmit the driving signal generated by the signal generator 501 to the thin film structure.

The thermoacoustic system 500 of FIG. 5 operates in the same way as that described above with respect to FIGS. 1-4. That is, an acoustic wave 508 is generated at the junction 504 in response to temperature fluctuations generated by the Peltier effect (predominantly) when an AC driving signal is applied across the junction 504.

It will be appreciated that the use of thin film materials in the manner described above may be advantageous to provide thin and robust emitters. The structure of the emitter, i.e. having no moving parts, lends itself well to small scale fabrication methods such as thin film techniques. Further, the thin-film structure can be modified to tailor the sound-field pattern of the acoustic waves. For example, if the drive frequency is selected such that the wavelength of the driving signal and the size of the interface 504 are comparable, then the sound-field pattern will be dictated by the shape of the interface 504.

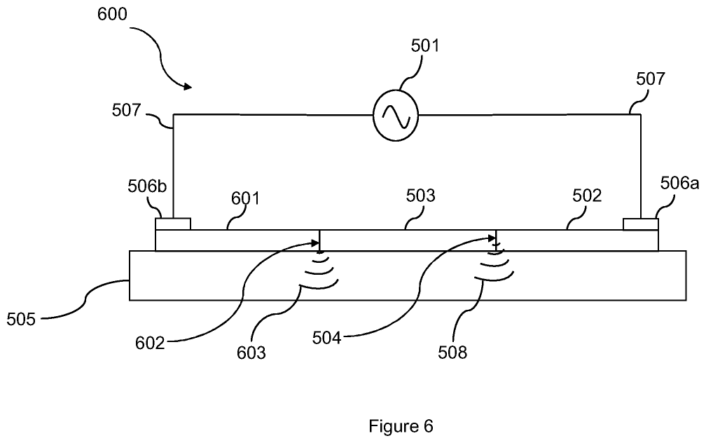

The present disclosure has been described above with respect to the underlying working principles and structure. However it will be appreciated that the thermoacoustic system of the present disclosure is widely applicable to many different applications, some of which will now be described with respect to FIGS. 6-8.

FIG. 6 is a diagram which schematically illustrates a thermoacoustic system 600 in accordance with an embodiment of the present disclosure, where the system 600 forms an acoustic dipole.

The thermoacoustic system 600 corresponds substantially to that described above with respect to FIG. 5, and like references are used to denote like features in the drawings. However, the embodiment of FIG. 6 differs from that of FIG. 5 in that it further comprises a third thin film conductor 601 which interfaces with the second thin film conductor 503. Further, the second electrical contact 506b is not connected to the end of the second thin film conductor 503, but rather the end of the third thin film conductor 601 opposite the second thin film conductor 503.

In this way, a second thermocouple junction 602 is formed in series connection with the first thermocouple junction 504 via the second thin film conductor 503. Further, the thermoacoustic system 600 can be said to have two pairs of electrical conductors, wherein the pairs are electrically connected in series such that one of the electrical conductors of a first pair forms one of the electrical conductors of a second pair.

The first thin film conductor 502 and the third thin film conductor 601 are made of the same electrically conductive material, referred to herein as the “first conductive material”, whereas the second thin film conductor 503 is made of a second conductive material which is dissimilar to the first conductive material. When a driving signal is applied to the system 600, current will travel from the first conductive material to the second conductive material at one of the junctions, and from the second conductive material to the first conductive material at the other junction.

As each junction will be either heated or cooled depending on the current direction, i.e. whether the current goes from the first conductive material to the second conductive material or vice versa, a current will cause heating to occur at one junction (e.g. the first junction 504) and cooling to occur at the other junction (e.g. the second junction 602). Accordingly, when the signal generator 501 operates to supply an AC driving signal such that each junction repeatedly switches from heating to cooling in an alternating manner, the adjacent junctions (i.e. the first and second junctions 504, 602) will generate pressure fluctuations and thus acoustic waves 508, 603 that are out-of-phase, thereby operating as an acoustic dipole.

While the example embodiments have been described above with respect to providing two series connected thermocouple junctions that together form an acoustic dipole, the thermoacoustic system may comprise more than two thermocouple junctions which are connected in series. For example, the system may comprise an alternating series of the first electrically conductive material and the second electrically conductive material. Further, systems could be made with specific series combinations of electrically conductive materials having different material properties, such that an acoustic phased array is produced upon application of an electric current. The ability to achieve this with thin-film systems may be highly advantageous.

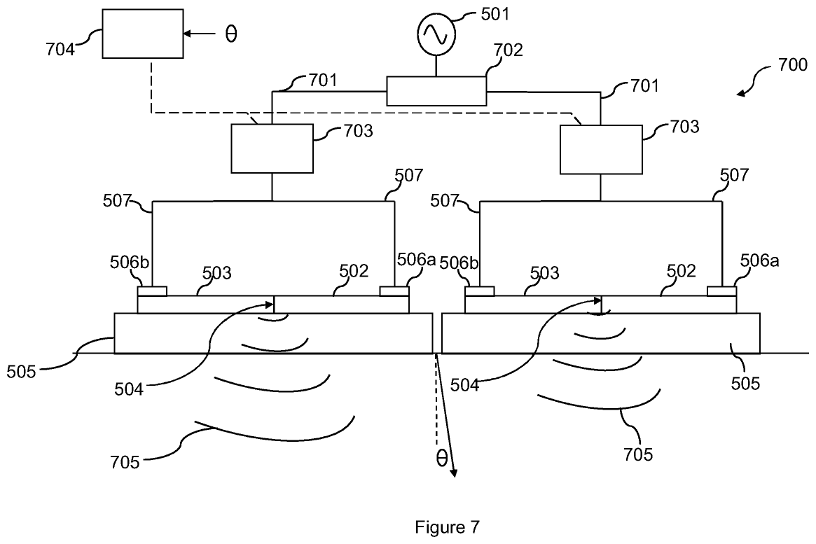

FIG. 7 is a diagram which schematically illustrates a thermoacoustic system 700 in accordance with another embodiment of the present disclosure, in which the system 700 in effect forms an acoustic phased array. Such an array may be used in the field of phased array ultrasonics, which has applications in fields of medical imaging and industrial non-destructive testing.

In this embodiment, the system comprises a first pair of electrical conductors 502, 503 and a second pair of electrical conductors 502, 503, wherein each pair comprises conductors formed of dissimilar conductive materials (a first conductive material and a second conductive material) that connect at an interface to form an electrical thermocouple junction 504. Further, the conductive materials forming the first pair are the same conductive materials as those forming the second pair.

Each pair of electrical conductors 502, 503 are supplied with the same electronic driving signal from a signal generator 501 via respective feed lines 701, where the driving signal generated at the signal generator 501 is split into the respective feed lines by a signal splitter device 702.

Along each feed line 701, there is provided a programmable delay unit 703, which operates under the direction of a microprocessor controller 704 to impart a time delay which corresponds to a suitable phase delay, O, to the driving signal. Any suitable delay unit known in the art may be used for this. Accordingly, the system 700 operates to supply the thermocouple junctions 504 with the same driving signal but in a time delayed manner, thereby causing the thermocouple junctions 504 to emit acoustic waves 705 in a phase delayed manner relative to one another. The timing of the acoustic waves emitted by each pair of conductors is controlled by the programmable delay units 703 and controller 704.

For many applications, the system 700 can be used to generate pulses of acoustic waves oscillating at an ultrasonic frequency which may be used to penetrate an object to be interrogated. For example, in medical imaging fields, an array of respective pairs of conductors may be brought into contact with the skin of a patient, such that the ultrasonic waves travel through the tissue and can be subsequently detected (using other means).

It will be appreciated here that the above embodiment need not have a single signal generator, or a delay unit for each pair of electrical conductors. In alternative embodiments, the system 700 may comprise a respective signal generator for each pair of electrical conductors (thermocouple junctions), the operation of which can be controlled (e.g. in a time delayed manner) by one or more microprocessor controllers.

Although the disclosure has been described above with respect to the first electrical conductor and the second electrical conductor being fixedly connected to one another to form the electrical junction, this is not required. In alternative embodiments, the second electrical conductor may itself be a sample that is to be interrogated with acoustic waves, and the first electrical conductor may be a probe that is brought into contact or wire bond with the sample to form the electrical junction at the interface.

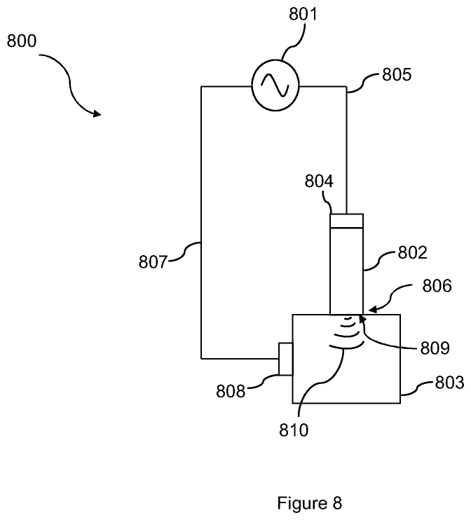

FIG. 8 is a diagram which schematically illustrates one such embodiment. There is generally shown an acoustic system 800 comprising an electronic signal generator 801, a first electrical conductor 802 and a sample 803 to be interrogated.

The first electrical conductor 802 is connected to the signal generator 801 via a first electrical wire 805, which is attached to the first electrical conductor 802 using a first electrical contact 804. The system 800 further comprises a second electrical wire 807 which connects the signal generator 801 to a second electrical contact 808 at opposite ends of the wire 807.

Both the first electrical conductor 802 and the second electrical contact 808 are movable relative to the signal generator 801 and sample 803, such that they can be brought into contact with the sample 803 to form a closed electrical circuit with the signal generator 801. When in a contact position with the sample 803, the first electrical conductor 802 contacts the sample 803 to form an electrical junction 809 at an interface therebetween. In embodiments where the sample 803 is formed of a dissimilar material to that of the first electrical conductor 801, the interface forms a thermocouple junction.

As described above with respect to equation 1, the electronic signal generator 801 is configured to generate a driving signal across the electrical junction 809, to thereby generate an acoustic wave 810 that is emitted from the junction 809 and will penetrate the sample 803 from the interface. The depth of penetration may be selected or controlled by appropriate selection of the drive frequency and/or power (driving or bias currents) of the driving signal.

Although not shown, one or more detectors may be provided as part of the system 800 so as to detect and record the acoustic waves following interaction with the sample 803. For example, a detector may be used to detect acoustic waves that have been reflected from points within the sample 803, and may give an indication of the internal structure of the sample 803.

From the above, it can be seen that the present disclosure provides a novel system for thermoacoustic generation, whereby a thermocouple junction is driven by an AC driving signal to cause the system to generate an acoustic wave predominantly by the Peltier effect rather than Joule heating. This method of sound generation leads to advantages and applications that cannot be achieved by Joule-based thermoacoustic systems.

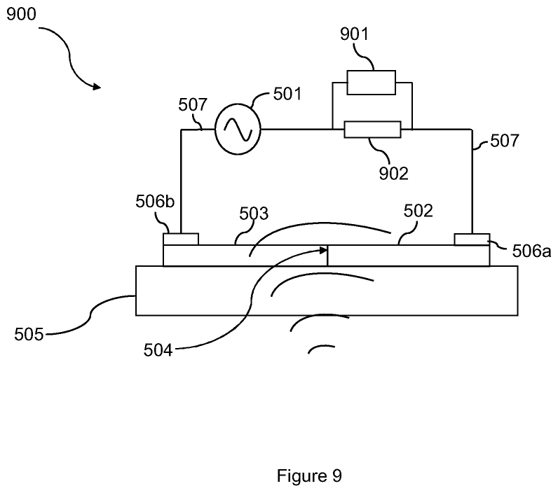

The thermoacoustic system may also or instead be configured to operate as a detector of incoming acoustic waves that impinge the thermocouple junction, as will now be described with respect to FIG. 9.

FIG. 9 is a schematic diagram illustrating a thermoacoustic system 900 in accordance with an embodiment of the present disclosure, in which the system 900 is configured to operate as an acoustic detector.

In this embodiment, the thermoacoustic system 900 corresponds substantially to that described above with respect to FIG. 5, and like references are used in the Figures to denote like features. However, the embodiment of FIG. 9 differs from that of FIG. 5 in that the system 900 further comprises a voltmeter 901 and a resistor 902 of fixed, known resistance. The resistor 902 is connected in series with the circuit but the voltmeter 901 is connected in parallel to the circuit such that it is configured to detect a voltage across the resistor 902.

The electronic signal generator 501 is configured to operate by generating and supplying the circuit with an AC or DC voltage across the electrical junction 504, such that the junction 504 will be maintained at a known or predictable temperature (according to Peltier and/or Joule effects) in the absence of any other heat sources. Should an acoustic wave impinge the electrical junction 504 during this operation, the wave will cause temperature fluctuations at the thermocouple junction 504. This in turn will cause a change in the resistance and thus thermoelectric voltage across the junction 504, which can be detected by the voltmeter 901. This change in voltage is indicative of and corresponds to the thermoelectric voltage that is induced across the electrical junction in response to an acoustic wave impinging the system 900. Accordingly, the original acoustic wave incident on the junction 504 can be reproduced and generated based on the detected voltage changes.

In further embodiments which are not shown, the pair of conductors 502, 503 may be located within a Helmholtz resonator, i.e. a housing which defines an enclosed volume in fluid (air) communication with the outside via a single opening. When an acoustic wave having a frequency at the resonant frequency of the Helmholtz resonator arrives at the opening to the housing, air will be drawn back and forth across the junction 504 at that frequency. This will increase the temperature fluctuations and thus the thermoelectric voltage fluctuations across the junction 504, which can be detected by the voltmeter 901.

Although the thermoacoustic detector system 900 of FIG. 9 has been described with respect to detecting a voltage difference across the junction 504, this is not required. In other embodiments, the system 900 may comprise an ammeter (not shown) which is in series connection with the signal generator 501 and pair of electrical conductors 502, 503, and is configured to detect changes in current which are indicative of a thermoelectric current induced across the electrical junction in response to an acoustic wave impinging the system at the interface. The ammeter may replace the voltmeter 901 and resistor 902 in the embodiment of FIG. 9.

While the example embodiments have been described above with respect to a pair of Chromel and Alumel conductors, the present disclosure extends to any pair of dissimilar, electrically conductive materials suitable for forming a thermocouple. Suitable materials include, but are not limited to, platinum, copper, chromium, iron, aluminium, nickel, and their alloys. The pair of electrical conductors may comprise a first conductive material of Copper and a second conductive material of Constantan (an alloy comprising approx. 55% copper and 45% nickel).

Further, the Applicant has found that the magnitude of the first harmonic response will be much greater in embodiments where the electrical conductors comprise magnetic materials, as compared to the first harmonic response generated by a pair of non-magnetic conductors. Accordingly, in some embodiments, the pair of electrical conductors are magnetic materials.

Embodiments of the present disclosure have been described above with reference to the accompanying drawings, in which some, but not all embodiments are shown. It will be appreciated that whilst various aspects and embodiments of the present disclosure have heretofore been described, the scope of the present disclosure is not limited to the embodiments set out herein and instead extends to encompass all methods and arrangements, and modifications and alterations thereto, which fall within the scope of the appended claims.

1. A thermoacoustic system comprising:
a pair of electrical conductors comprising a first electrical conductor and a second electrical conductor formed of dissimilar materials, wherein the first and second electrical conductors connect at an interface to form an electrical junction; and
an electronic signal generator for generating an alternating current driving signal across the electrical junction, thereby causing the system to generate an acoustic wave that is emitted from the interface.

2. The thermoacoustic system of claim 1, wherein the electrical conductors are formed of dissimilar materials in that they have different values of a thermoelectric coefficient.

3. The thermoacoustic system of claim 2, wherein the thermoelectric coefficient is one of the Seebeck, Peltier or Thomson coefficients.

4. The thermoacoustic system of claim 1, wherein the first electrical conductor comprises Copper and the second electrical conductor comprises Constantan.

5. The thermoacoustic system of claim 1, wherein the first electrical conductor and/or the second electrical conductor comprise magnetic materials.

6. The thermoacoustic system of claim 5, wherein the first electrical conductor comprises Chromel and the second electrical conductor comprises Alumel.

7. The thermoacoustic system of claim 1, wherein the electronic signal generator is configured to generate a driving signal having a driving current or bias current equal to or greater than a predetermined threshold value corresponding to a minimum thermoacoustic response at the first harmonic.

8. The thermoacoustic system of claim 1, wherein the driving signal has a mean amplitude of zero.

9. The thermoacoustic system of claim 1, wherein the electronic driving signal has a mean amplitude equal to or greater than a predetermined threshold value corresponding to a minimum thermoacoustic response at the first harmonic.

10. The thermoacoustic system of claim 1, wherein the driving signal has a drive frequency between 20 Hz and 20 kHz.

11. The thermoacoustic system of claim 1, wherein the first and second electrical conductors are thin-film conductors deposited onto a substrate.

12. The thermoacoustic system of claim 1, comprising two pairs of electrical conductors, wherein the pairs are electrically connected in series such that the second electrical conductor of a first pair forms the first electrical conductor of a second pair.

13. The thermoacoustic system of claim 1, further comprising a third electrical conductor, wherein the first, second and third electrical conductors comprise two different electrically conductive materials which are connected in series in an alternating manner.

14. The thermoacoustic system of claim 1, further comprising:
a second pair of electrical conductors, comprising a first electrical conductor and a second electrical conductor formed of dissimilar materials, wherein the first and second electrical conductors of each pair connect at an interface to form an electrical junction;
the electronic signal generator being configured to generate an alternating current driving signal across the electrical junctions, thereby causing the system to generate acoustic waves that are emitted from the interfaces; and
a controller configured to cause the at least two pairs of electrical conductors to emit pulses of acoustic waves in a phase or time delayed manner.

15. A thermoacoustic system for probing an electrically conductive sample, the system comprising:
a first electrical conductor formed of a dissimilar material to that of the sample; and
an electronic signal generator;
wherein:
the first electrical conductor is movable to a contact position at which it contacts the sample to form an electrical junction at an interface therebetween; and
the electronic signal generator is configured to generate a driving signal across the electrical junction, to generate an acoustic wave that enters the sample from the interface.

16. A thermoacoustic system comprising:
a pair of electrical conductors comprising a first electrical conductor and a second electrical conductor formed of dissimilar materials, wherein the first and second electrical conductors connect at an interface to form an electrical junction;
an electronic signal generator for generating a driving signal across the electrical junction; and
a detector configured to detect a thermoelectric voltage or current that is induced across the electrical junction in response to an acoustic wave impinging the system at the interface.

17. (canceled)

18. (canceled)

19. The thermoacoustic system of claim 15 further comprising a second electrical conductor which contacts the sample to form a second electrical junction therewith and wherein the second electrical conductor is movable relative to the sample.

20. The thermoacoustic system of claim 15 wherein a depth of penetration of the acoustic wave within the sample is controllable by appropriate selection of a drive frequency and/or a power (driving or bias currents) of the driving signal.

21. The thermoacoustic system of claim 15 comprising at least one detector configured to detect and optionally record the acoustic waves following interaction with the sample.

22. The thermoacoustic system of claim 15 wherein the at least one detector is configured to detect acoustic waves reflected from points within the sample and to provide an indication of an internal structure of the sample.
